(19) United States
(12) Patent Application Publication
(10) Pub. No.: US 2024/0345547 A1
(43) Pub. Date: Oct. 17, 2024

(54) OPERATION RULE DETERMINATION DEVICE, OPERATION RULE DETERMINATION METHOD, AND RECORDING MEDIUM

(71) Applicant: NEC Corporation, Minato-ku, Tokyo (JP)

(72) Inventors: Takuya HIRAOKA, Tokyo (JP); Takashi Onishi, Tokyo (JP)

(73) Assignee: NEC Corporation, Minato-ku, Tokyo (JP)

(21) Appl. No.: 18/294,590

(22) PCT Filed: Aug. 23, 2021
(86) PCT No.: PCT/JP2021/030873

§ 371 Date: Feb. 2, 2024

(51) Int. Cl. G05B 13/02; G05B 13/04

(52) U.S. Cl. CPC G05B 13/0265; G05B 13/042

(57) ABSTRACT

An operation rule determination device includes: an evaluation function setting unit that sets a second evaluation function that has been altered from a first evaluation function in which a condition relating to operation of a controlled object is reflected, such that a difference in an evaluation function between time steps of evaluation relating to the operation of the controlled object is reduced; and a learning unit that performs learning on an operation rule of the controlled object using the second evaluation function, and performs learning on the operation rule of the controlled object using a learning result and the first evaluation function.

### TECHNICAL FIELD

The present invention relates to an operation rule determination device, an operation rule determination method, and a recording medium.

### BACKGROUND ART

In the learning of an operation rule of a controlled object, conditions relating to operation can sometimes be set.

For example, in the reinforcement learning method described in Patent Document 1, when the time interval in which a state measurement of a controlled object is performed and the time interval in which an action determination is performed with respect to the object are different, a past state is predicted to calculate a degree of risk of a constraint condition for the predicted state. Further, in the reinforcement learning method, an action is determined by specifying, with respect to the controlled object, a search range relating to the current action according to the calculated degree of risk and a degree of influence of the current action on the state subjected to the degree of risk calculation.

### PRIOR ART DOCUMENTS

### Patent Documents

Patent Document 1: Japanese Unexamined Patent Application, First Publication No. 2021-33767

### SUMMARY OF THE INVENTION

### Problems to be Solved by the Invention

In the learning of an operation rule of a controlled object, when conditions relating to operation are set, the learning can sometimes become relatively difficult due to setting of the conditions. In this case, it is preferable to take measures to reduce the degree to which the learning becomes difficult.

An example object of the present invention is to provide an operation rule determination device, an operation rule determination method, and a recording medium that are capable of solving the problem described above.

### Means for Solving the Problem

According to a first example aspect of the present invention, an operation rule determination device includes: an evaluation function setting unit that sets a second evaluation function that has been altered from a first evaluation function in which a condition relating to operation of a controlled object is reflected, such that a difference in an evaluation function between time steps of evaluation relating to the operation of the controlled object is reduced; and a learning unit that performs learning on an operation rule of the controlled object using the second evaluation function, and performs learning on the operation rule of the controlled object using a learning result and the first evaluation function.

According to a second example aspect of the present invention, an operation rule determination method executed by a computer includes: setting a second evaluation function that has been altered from a first evaluation function in which a condition relating to operation of a controlled object is reflected, such that a difference in an evaluation function between time steps of evaluation relating to the operation of the controlled object is reduced; and performing learning on an operation rule of the controlled object using the second evaluation function, and performing learning on the operation rule of the controlled object using a learning result and the first evaluation function.

According to a third example aspect of the present invention, a recording medium stores a program that causes a computer to execute: setting a second evaluation function that has been altered from a first evaluation function in which a condition relating to operation of a controlled object is reflected, such that a difference in an evaluation function between time steps of evaluation relating to the operation of the controlled object is reduced; and performing learning on an operation rule of the controlled object using the second evaluation function, and performing learning on the operation rule of the controlled object using a learning result and the first evaluation function.

### Effect of Invention

According to the operation rule determination device, the operation rule determination method, and the recording medium described above, in the learning of an operation rule of a controlled object, when setting conditions relating to operation causes the learning to become relatively difficult, it is possible to take measures to reduce the degree to which the learning becomes difficult.

### BRIEF DESCRIPTION OF THE DRAWINGS

FIG. 1 is a diagram showing a configuration example of a control system according to an example embodiment.

FIG. 2 is a diagram showing a configuration example of an operation rule determination device according to an example embodiment.

FIG. 3 is a diagram showing an example of a first turn of a first episode.

FIG. 4 is a diagram showing an example of a second turn of the first episode.

FIG. 5 is a diagram showing an example of a third turn of the first episode.

FIG. 6 is a diagram showing an example of a first turn of a second episode.

FIG. 7 is a diagram showing an example of a second turn of the second episode.

FIG. 8 is a diagram showing an example of history information that is stored by a history information acquisition unit according to an example embodiment.

FIG. 9 is a diagram showing an example of a condition relating to operation of a controlled object according to an example embodiment.

FIG. 10 is a diagram showing a first example of risk-sensitive history information according to an example embodiment.

FIG. 11 is a diagram showing a second example of risk-sensitive history information according to an example embodiment.

FIG. 12 is a diagram showing a third example of risk-sensitive history information according to an example embodiment.

FIG. 13 is a diagram showing an example of a processing procedure by which an operation rule determination device according to an example embodiment determines an operation rule of a controlled object by learning.

FIG. 14 is a diagram showing an example of a processing procedure performed in a case where a history information acquisition unit according to an example embodiment acquires history information by simulation.

FIG. 15 is a diagram showing an example of a procedure by which a learning unit according to an example embodiment performs operation rule evaluation processing.

FIG. 16 is a diagram showing an example of a configuration of an operation rule determination device according to an example embodiment.

FIG. 17 is a diagram showing an example of a processing procedure of an operation rule determination method according to an example embodiment.

FIG. 18 is a schematic block diagram showing a configuration of a computer according to at least one example embodiment.

### EXAMPLE EMBODIMENT

Hereunder, an example embodiment of the present invention will be described. However, the following example embodiment does not limit the invention according to the claims. Furthermore, not all combinations of features described in the example embodiment are essential to the solution means of the invention.

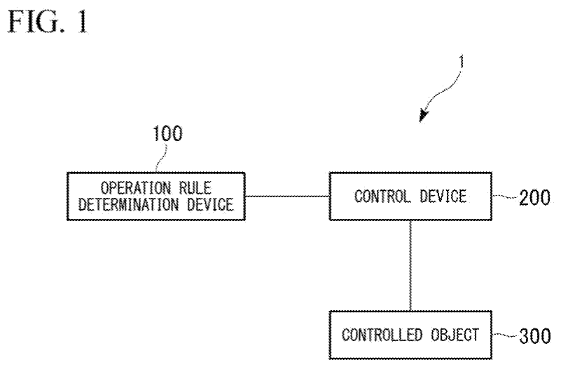

FIG. 1 is a diagram showing a configuration example of a control system according to an example embodiment. In the configuration shown in FIG. 1, the control system 1 includes an operation rule determination device 100, a control device 200, and a controlled object 300.

The control system 1 controls the controlled object 300. Specifically, the operation rule determination device 100 determines an operation rule of the controlled object 300 using reinforcement learning. The control device 200 determines the operation of the controlled object 300 based on the operation rule determined by the operation rule determination device 100, and causes the controlled object 300 to execute the determined operation.

The reinforcement learning referred to here is machine learning that learns an operation rule that determines the operation of a controlled object in a certain environment based on; the operation of the controlled object, an observed state of the environment and the controlled object, and a reward that represents an evaluation of the state or the operation of the controlled object.

The operation of the controlled object 300 corresponds to an action. The operation of the controlled object 300 is also referred to as an action below. The operation rule corresponds to a policy. The operation rule is also referred to as a policy below. The evaluation relating to the operation of the controlled object 300 corresponds to a reward.

Hereunder, an example will be described in which the reward is used as an evaluation function in the learning, but it is not limited to this. For example, it is possible to use, as the evaluation function in the learning, an evaluation function whose value decreases as the evaluation increases.

The operation rule determination device 100 performs learning using history information that includes information representing the state and the operation of the controlled object 300 at each time step. Therefore, when the operation rule determination device 100 performs the learning, it is not necessary for the control device 200 to operate the controlled object 300 in real time.

Alternatively, the operation rule determination device 100 may output an operation rule of the controlled object 300 to the control device 200, and acquire the history information by causing the control device 200 to operate the controlled object 300 based on the operation rule. Then, the operation rule determination device 100 may perform the learning using the obtained history information, and calculate an operation rule as a learning result. The operation rule determination device 100 may output the obtained operation rule to the control device 200, and repeat the learning of the operation rule using the history information acquired from the control device 200.

The operation rule determination device 100 may, for example, be configured using a computer. Alternatively, the operation rule determination device 100 may be configured using dedicated hardware for the operation rule determination device 100, and may be configured using an ASIC (Application Specific Integrated Circuit), an FPGA (Field Programmable Gate Array), or the like. Similarly, the controlled object 300 is, for example, configured using a computer. Alternatively, the controlled object 300 may be configured using dedicated hardware for the controlled object 300, and may be configured using an ASIC or an FPGA.

When the operation rule determination device 100 learns the operation rule, the control device 200 and the controlled object 300 do not have to be present. Furthermore, when the control device 200 operates the controlled object 300, the operation rule determination device 100 does not have to be present, and the control device 200 only needs to have acquired the operation rule.

Alternatively, the operation rule determination device 100 and the control device 200 may be integrally configured. For example, the operation rule determination device 100 and the control device 200 may be implemented by the same computer.

The configuration of the controlled object 300 is not limited to a specific object. For example, the controlled object 300 may be a moving body such as a car, an airplane, or a ship. Alternatively, the controlled object 300 may be a processing factory or a facility or device subjected to control, such as a manufacturing process. The controlled object 300 can be various objects that can be controlled by the control device 200, and for which a condition relating to operation of the controlled object 300 is set, such as a constraint condition that is set in order to avoid a specific state.

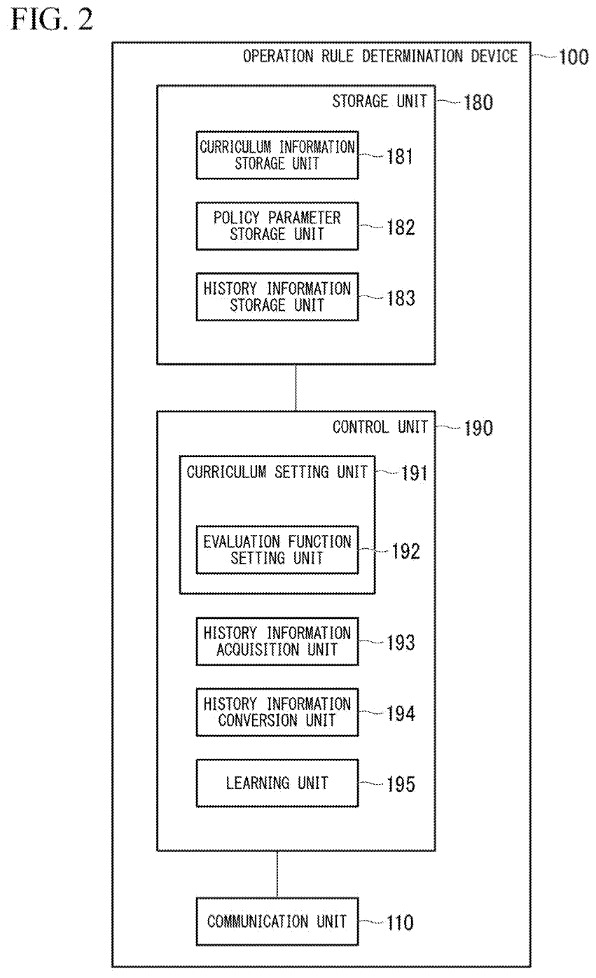

FIG. 2 is a diagram showing a configuration example of the operation rule determination device 100. In the configuration shown in FIG. 2, the operation rule determination device 100 includes a communication unit 110, a storage unit 180, and a control unit 190. The storage unit 180 includes a curriculum storage unit 181, a policy parameter storage unit 182, and a history information storage unit 183. The control unit 190 includes a curriculum setting unit 191, a history information acquisition unit 193, a history information conversion unit 194, and a learning unit 195. The curriculum setting unit 191 includes an evaluation function setting unit 192.

The communication unit 110 performs communication with other devices. For example, the communication unit 110 may transmit the operation rule determined by the operation rule determination device 100 to the control device 200.

The storage unit 180 stores various information. The storage unit 180 is configured by using a storage device included in the operation rule determination device 100.

The curriculum storage unit 181 stores curriculum information. The curriculum information is setting information for progressing the learning of the operation rule performed by the operation rule determination device 100 in stages. The operation rule determination device 100 efficiently performs the learning by progressing the learning of the operation rule from easy learning to difficult learning in stages.

Here, when the learning is difficult, the policy optimization may become unstable if the learning is directly performed under a certain setting without performing the learning in stages. Alternatively, when the learning is difficult, the evaluation of a learning result may be low such that the learning result does not meet a specified condition, or a long time may be required to obtain a high evaluation if the learning is directly performed under a certain setting without performing the learning in stages.

For example, a case will be considered in which a constraint condition to be satisfied by a series of operations of the controlled object 300 is set. The series of operations of the controlled object 300 is also referred to as an episode.

As a method of incorporating a constraint condition into a reinforcement learning framework, a method will be considered in which a penalty is added to the reward value of the final turn of an episode if the constraint condition is not satisfied. The addition of a penalty to a reward is performed by adding a predetermined negative value to a reward value that represents a higher evaluation as the reward value increases, that is to say, by subtracting a predetermined value from the reward value.

Here, one turn of an episode represents one time step. It is assumed that time is expressed in time steps, and the controlled object 300 and the control device 200 observe the state, determine an action, and perform the action once per turn.

If a penalty is added to the reward value, by adding the penalty to the reward value for only the final turn of the episode, a large change occurs in the reward value between the turn before the final turn and the final turn. Such a large change in the reward value is considered to make the learning difficult.

Therefore, the operation rule determination device 100 sets the learning framework such that fluctuations due to differences in the reward value of each turn are reduced. For example, the operation rule determination device 100 may perform a calculation that corresponds to the addition of a penalty to the reward value in a turn that is different from the final turn of the episode. Alternatively, the operation rule determination device 100 may reduce the determination threshold for penalty addition to reduce the frequency in which a penalty occurs.

The operation rule determination device 100 performs the learning by performing the relatively easy learning, and then setting the operation rule obtained as a learning result as an initial value of the operation rule in the more difficult learning. As a result, it is expected that the operation rule determination device 100 will be capable of efficiently performing the more difficult learning.

In this case, the framework of each individual learning is referred to as a curriculum.

The policy parameter storage unit 182 stores policy parameter values. The policy parameters are the learning parameters in a policy model, which is a learning model of the operation rule. A policy (operation rule) is obtained as a result of setting the policy parameters to a policy model. The learning of a policy is performed by updating the policy parameter values.

The expression format of the policy model used by the operation rule determination device 100 is not limited to a specific expression format. For example, the policy model may be configured as a mathematical expression that contains parameters. Alternatively, the policy model may be configured using a neural network.

The history information storage unit 183 stores history information about the operation of the controlled object 300. The history information is used as training data for reinforced learning of the operation rule. The history information represents, for each turn; an episode identification number, the turn number in the episode, an action, a state, and a reward.

The episode identification number may be, for example, a consecutive number starting from 1 according to the execution order of the episodes. The turn number in the episode may also be represented by a consecutive number starting from 1. The action may be represented by a control command value of the controlled object 300, such as a command value of a motor of the controlled object 300. The state may be represented by a sensor measurement value relating to the controlled object 300 or the environment. If the reward function is known, and it is possible to calculate the reward value from the action and the state, information about the reward value does not have to be included in the history information.

The control unit 190 executes various processing by controlling each unit of the operation rule determination device 100. The functions of the control unit 190 are executed as a result of a CPU (Central Processing Unit) included in the operation rule determination device 100 reading and executing a program from the storage unit 180.

The curriculum setting unit 191 sets a curriculum. For example, when curriculum 0, curriculum 1, and curriculum 2 are to be executed in this order, the curriculum setting unit 191 firstly sets curriculum 0. When the learning with curriculum 0 proceeds and a completion condition of curriculum 0 is met, the curriculum setting unit 191 sets curriculum 1. In this way, the curriculum setting unit 191 sets and updates the curriculum.

The curriculum setting unit 191 may indicate the curriculum currently being executed by setting and updating a counter value that stores the curriculum number.

Furthermore, when starting a curriculum, the curriculum setting unit 191 performs various settings for executing the curriculum, such as setting a function for executing the curriculum. For example, when a curriculum is set by setting a rewritten reward rule, the evaluation function setting unit 192 of the curriculum setting unit 191 sets a rewritten reward rule at the start of each curriculum.

The evaluation function setting unit 192 sets a reward function for each curriculum. Alternatively, when the history information indicates a reward value, the evaluation function setting unit 192 may set a rewritten reward value rule for each curriculum.

Specifically, the evaluation function setting unit 192 sets a second evaluation function that has been altered from a first evaluation function in which a condition relating to operation of the controlled object 300 is reflected, such that a difference in an evaluation function between time steps of evaluation relating to operation of the controlled object 300 is reduced.

Here, the first evaluation function is a reward function that reflects a penalty-added rule when a condition relating to operation of the controlled object 300 (constraint condition) is not satisfied. The second evaluation function is a reward function that has been altered from the first evaluation function such that the difference in the reward function between turns is reduced.

The second evaluation function is an evaluation function that has been rewritten such that the learning is more easily performed than when the first evaluation function is used, and represents a setting in which an operation rule is desired as a final learning result. The operation rule determination device 100 performs the learning using the first evaluation function in the final curriculum of the learning of the operation rule. On the other hand, the operation rule determination device 100 performs the learning using the second evaluation function in a curriculum before the final curriculum of the learning of the operation rule.

The first evaluation function may be set such that a condition is reflected in the final time step among the time steps of the series of operations of the controlled object 300. For example, a penalty may be added to the reward value when the condition is not met in the final turn of the episode as described above.

Then, the evaluation function setting unit 192 may generate the second evaluation function from the first evaluation function, such that alternation is performed in which a condition based on the condition of the final time step is reflected, among the time steps of the series of operations of the controlled object 300, in a time step that is different from the final time step.

“The second evaluation function from the first evaluation function, such that alternation is performed in which a condition based on the condition of the final time step is reflected, among the time steps of the series of operations of the controlled object 300, in a time step that is different from the final time step” corresponds to an example of “the second evaluation function that has been altered from the first evaluation function such that the difference in the evaluation function between time steps of evaluation relating to operation of the controlled object 300 is reduced.”

The first evaluation function may be set such that the evaluation relating to operation of the controlled object 300 is decreased when the evaluation relating to operation of the controlled object 300 is a lower evaluation than a threshold. Further, the evaluation function setting unit 192 may generate the second evaluation function from the first evaluation function, such that the threshold is altered so that the evaluation relating to operation of the controlled object 300 is more likely to become a high evaluation that is greater than or equal to the threshold.

“The second evaluation function from the first evaluation function, such that the threshold is altered so that the evaluation relating to operation of the controlled object 300 is more likely to become a high evaluation that is greater than or equal to a threshold” corresponds to an example of “the second evaluation function that has been altered from the first evaluation function such that a difference in an evaluation function between time steps of evaluation relating to operation of the controlled object 300 is reduced.”

The history information acquisition unit 193 acquires history information. For example, the history information acquisition unit 193 includes a simulator that simulates the controlled object 300 and the environment, and executes simulations. At the time of a simulation, the history information acquisition unit 193 determines the operation of the controlled object 300 according to the operation rule set by the learning unit 195, and simulates the determined operation.

The history information acquisition unit 193 generates, for each time step in the execution of the simulation, history information containing information representing the state, information representing the operation of the controlled object 300, and the reward value, and stores the history information in the history information storage unit 183.

The history information conversion unit 194 converts history information. Specifically, the history information conversion unit 194 performs a conversion that causes the reward value included in the history information to reflect a condition relating to the operation of the controlled object 300, and performs a conversion that reflects a supplementary reward for making the learning relatively easy.

The learning unit 195 uses the second evaluation function to learn the operation rule of the controlled object 300. Then, the learning unit 195 uses the learning result of the learning using the second evaluation function, and the first evaluation function to learn the operation rule of the controlled object 300.

The learning unit 195 may acquire an evaluation of the operation rule that has been set during learning of the operation rule. Then, if the obtained evaluation is lower than a predetermined condition, the learning unit 195 may once again set an operation rule that has been previously set.

Hereunder, an example of the operation of the controlled object 300 and an example of the history information will be described, and an example of rewriting the history information will be described. A robot called a hopper will be used as the controlled object to describe an example of operation of the hopper, and an example of the history information of operation of the hopper. Further, an example of rewriting the history information to reflect a constraint condition, and an example of rewriting the history information to make the learning easier will be described.

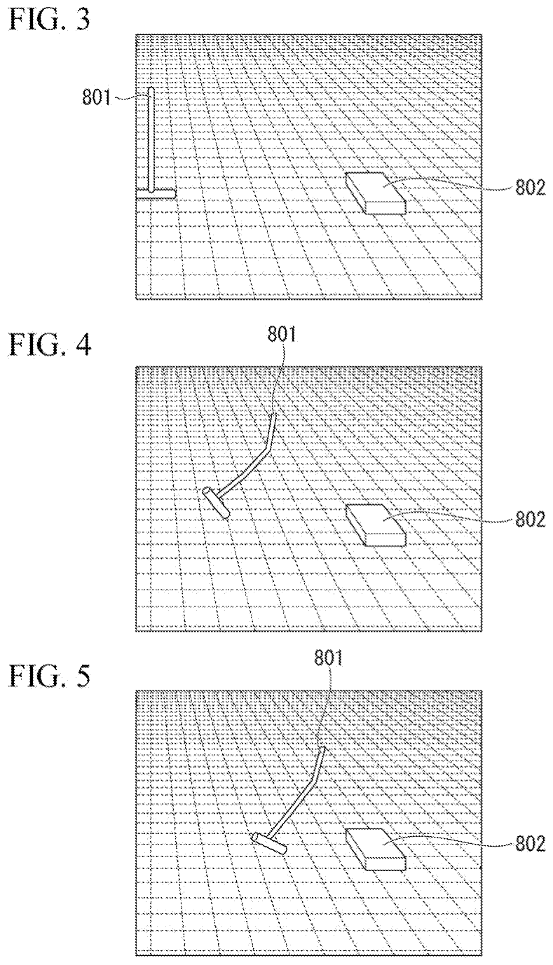

FIG. 3 is a diagram showing an example of a first turn of a first episode. Therefore, FIG. 3 shows the initial state of the first episode. In FIG. 3 to FIG. 7, a hopper 801 and a target position 802 are shown. The hopper 801 corresponds to an example of the controlled object 300. The target position 802 is located at the position of the progress target of the hopper 801. In the example in FIG. 3 to FIG. 7, the target position 802 is fixed. Therefore, the target position 802 is located in the same position in each turn of each episode.

FIG. 4 is a diagram showing an example of a second turn of the first episode. In the example of FIG. 4, the hopper 801 is closer to the target position 802 than in the first turn shown in FIG. 3.

FIG. 5 is a diagram showing an example of a third turn of the first episode. In the example of FIG. 5, the hopper 801 is closer to the target position 802 than in the second turn shown in FIG. 4. In the first episode, the maximum number of three turns has been reached in the example of FIG. 5. Therefore, the episode has ended.

The history information acquisition unit 193 stores, in the history information storage unit 183, history information which is a combination of the position information of the hopper 801 in two dimensional coordinates, the numerical value of the torque that causes operation of the hopper 801, and the reward from the first turn to the third turn in the first episode.

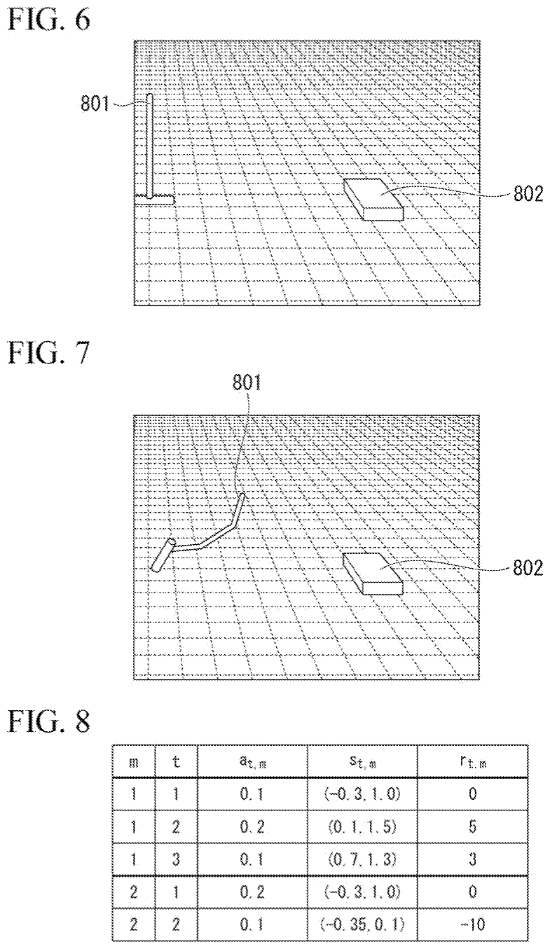

FIG. 6 is a diagram showing an example of a first turn of a second episode. Therefore, FIG. 6 shows the initial state of the second episode.

FIG. 7 is a diagram showing an example of a second turn of the second episode. In the example of FIG. 7, the hopper 801 has fallen over. Therefore, the episode has ended.

The history information acquisition unit 193 stores, in the history information storage unit 183, history information which is a combination of the position information of the hopper 801 in two dimensional coordinates, the numerical value of the torque controlling the operation of the hopper 801, and the reward from the first turn to the second turn in the second episode.

FIG. 8 is a diagram showing an example of the history information that is stored by the history information acquisition unit 193. In the example of FIG. 8, the history information is shown in a table format, and one row represents the history information relating to operation of the hopper 801 in one turn.

In FIG. 8, m represents the identification number of the episode. t represents the identification number of the turn. The operation a_{t,m} represents the numerical value of the torque controlling the operation of the hopper 801 in the tth turn of the mth episode. The state s_{t,m} represents the coordinates (position information) of the hopper 801 in the tth turn of the mth episode.

The reward r_{t,m} represents the reward in the tth turn of the mth episode.

In both the first turn of the first episode and the first turn of the second episode, the reward is 0 because these are both the initial state of the episode. In the second turn and the third turn of the first episode, a reward is provided according to the progress that the hopper 801 has made toward the target position 802. On the other hand, in the second turn of the second episode, a reward of −10 is provided because the hopper 801 has fallen over.

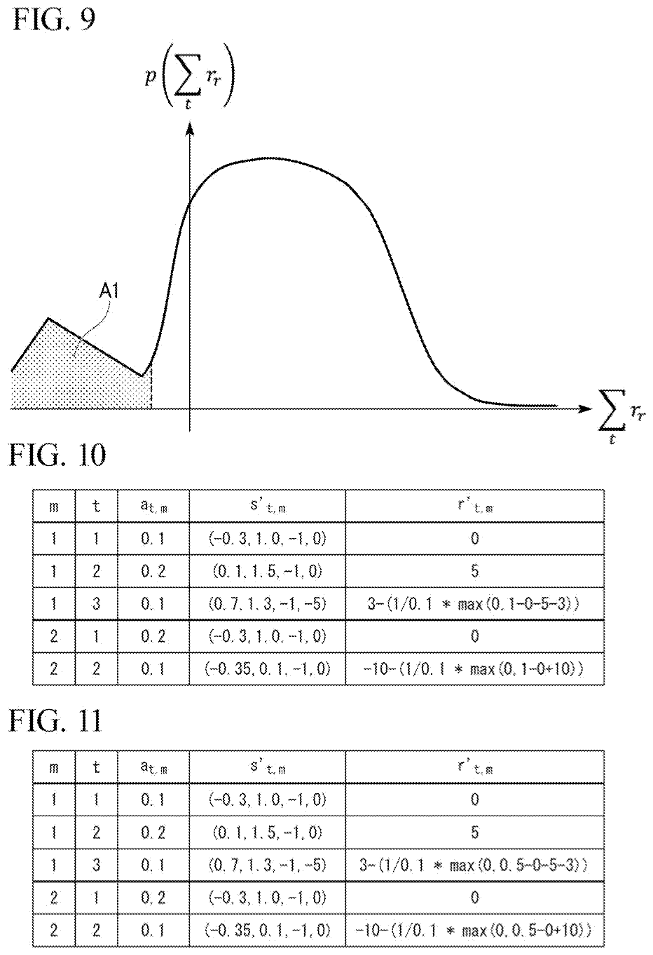

FIG. 9 is a diagram showing an example of a condition relating to operation of the controlled object 300. FIG. 9 shows an example of a probability distribution of the return obtained in an episode. The return referred to here is the total value of the rewards for one episode. That is to say, the return is the cumulative reward value for one episode.

The horizontal axis of FIG. 9 represents the return. The vertical axis represents the probability of obtaining the return shown on the horizontal axis.

The area A1 represents the lower ε% of the return distribution (where F is a real number with 0<ε<100). As the condition relating to operation of the controlled object 300, for example, a constraint condition is set such that the expected value of the lower ε % of the return distribution is greater than or equal to a specific threshold. Here, the lower side is the side consisting of small values. The expected value of the lower ε % of the return distribution is also referred to as CVaR (Condition Value At Risk). CVaR corresponds to the center of gravity of the area A1.

However, the condition relating to operation of the controlled object 300 is not limited to a specific condition.

FIG. 10 is a diagram showing a first example of risk-sensitive history information. The risk-sensitive history information is history information in which a condition relating to operation of the controlled object 300 has been reflected. The condition shown in FIG. 9 represents a constraint condition such that the controlled object 300 is operated so as to avoid a risk that causes the return to become less than or equal to a certain condition. The history information reflecting such a condition becomes training data for learning an operation rule that determines the operation of the controlled object 300 such that consideration is given to avoiding the risk.

In the example of FIG. 10, the history information conversion unit 194 generates risk-sensitive history information in which the state s_{t,m} of the history information in FIG. 9 is replaced with the risk-sensitive state information s′_{t,m}, and the reward r_{t,m} is replaced with the risk-sensitive reward r′_{t,m}.

The history information conversion unit 194 generates the risk-sensitive state information s′_{t,m} based on expression (1).

### [Expression 1]

$${s}_{t , m}^{′} := {s}_{t , m} ‖ ( v , {\sum }_{i = 0}^{t - 1} - {r}_{i , m} ) \qquad ( 1 )$$

Here, “∥” represents an operation that combines vector elements. That is to say, when the state s_{t,m} is expressed as (x_{t,m}, y_{t,m}), the risk-sensitive state information s′_{t,m} is expressed as (x_{t,m}, y_{t,m}, v, Σₜ₌₀^{Tm-1}−r_{t,m}).

Note that x_{t,m} represents the x coordinate of the position of hopper 801 in the tth turn of the mth episode. y_{t,m} represents the y coordinate of the position of hopper 801 in the tth turn of the mth episode. That is to say, the vector (x_{t,m}, y_{t,m}) corresponds to an example of the position information of hopper 801 in two-dimensional coordinates in the tth turn of the mth episode.

v represents the threshold for evaluating a risk based on a reward. Tₘ represents the turn number in the mth episode. In the example of FIG. 10, T₁=3, and T₂=2.

“Σₜ₌₀^{Tm-1}−r_{t,m}” represents the value obtained by multiplying the total value of the rewards from timing “0” to timing “Tₘ₋₁” in the mth episode by “−1”. That is to say, “Σₜ₌₀^{Tm-1}−r_{t,m}” can also be said to be the total value of the penalty from timing “0” to timing “Tₘ₋₁” in the mth episode.

v and Σₜ₌₀^{Tm-1}−r_{t,m} of the risk-sensitive state information s′_{t,m} are used to calculate the risk-sensitive reward r′_{t,m}. However, it is not essential to include such information in the risk-sensitive state information s′_{t,m}. For example, the storage unit 180 may store the threshold v separately from the risk-sensitive state information s′_{t,m}. Furthermore, if the history information conversion unit 194 uses the history of the state represented by the history information when calculating the risk-sensitive reward r′_{t,m}, it is not necessary to include “Σₜ₌₀^{Tm-1}−r_{t,m}” in the risk-sensitive state information s′_{t,m}.

Furthermore, the history information conversion unit 194 generates the risk-sensitive reward r′_{t,m} based on expression (2).

$$\begin{matrix}[ Expression 2 ] & \\ {r}_{t , m}^{′} = \{ \begin{matrix}{r}_{t , m} - \frac{1}{ε} max ( 0 , v + {\sum }_{i = 0}^{t} - {r}_{i , m} ) & ( t IS FINAL TIME ) \\ {r}_{t , m} & ( t IS OTHER THAN FINAL TIME )\end{matrix} & ( 2 )\end{matrix}$$

Here, (1/ε)max(0, v+Σₜ₌₀^{Tm}−r_{t,m}) in expression (2) represents the penalty, and ε is a coefficient that determines the level of importance of the penalty. For convenience of the description, ε is assumed to be a real constant.

In expression (2), since “-” is added to the reward r_{t,m}, the value of Σₜ₌₀^{Tm}−r_{t,m} increases as the total of the rewards r_{t,m} in the mth episode decreases. If the value of Σₜ₌₀^{Tm}−r_{t,m} is less than or equal to −v, 0 is selected in the max function of expression (2), and the penalty (1/ε)max(0, v+Σₜ₌₀^{Tm}−r_{t,m}) becomes 0. On the other hand, if the value of Σₜ₌₀^{Tm}−r_{t,m} is greater than −v, v+Σₜ₌₀^{Tm}−r_{t,m} is selected in the max function of expression (2), and the history information conversion unit 194 calculates the penalty as (1/ε)(v+Σₜ₌₀^{Tm}−r_{t,m}). The history information conversion unit 194 subtracts the penalty from the reward r_{t,m} and calculates the value as the risk-sensitive reward r′_{t,m}.

In this way, according to expression (2), a penalty is added to the reward value of the final turn of the mth episode when the return relating to the mth episode (cumulative reward value) is smaller than the threshold v. The reward value becomes smaller due to the addition of the penalty. As a result of the reward value being altered to a smaller value, it is expected that learning of the operation rule will proceed such that the controlled object 300 is less likely to take an action (operation) that causes the return to become smaller than the threshold v.

On the other hand, as a result of a penalty being added to the reward value of the final turn of the episode, there is a possibility of a sudden change from the reward value of the previous turn which, as mentioned above, may make learning difficult.

FIG. 11 is a diagram showing a second example of risk-sensitive history information. In the risk-sensitive history information shown in FIG. 11, the threshold (value of v) of the risk-sensitive history information shown in FIG. 10 has been altered from 1 to 0.5.

As a result, the number of episodes in which a penalty is added to the reward becomes smaller than when the value of the threshold is 1. In this respect, it can be said that the change causes a difference in the evaluation function between time steps of evaluation relating to operation of the controlled object 300 to be reduced. This is expected to reduce the frequency of sudden changes in the reward value due to addition of a penalty to the reward. In this respect, it is expected that the degree to which learning becomes difficult will be reduced.

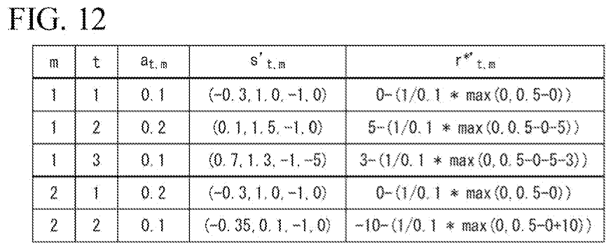

FIG. 12 is a diagram showing a third example of risk-sensitive history information. The risk-sensitive history information shown in FIG. 12 has been altered from the risk-sensitive history information shown in FIG. 11 by adding a supplementary reward.

In the example of FIG. 12, the value “−(1/0.1*max(0, 0.5−0))” of r*′_{t,m} when m=1 and t=1 corresponds to an example of a supplementary reward. The value “−(1/0.1*max(0, 0.5−0−5))” of r*′_{t,m} when m=1 and t=2 also corresponds to an example of a supplementary reward. The value “−(1/0.1*max(0, 0.5−0))” of r*′_{t,m} when m=2 and t=1 also corresponds to an example of a supplementary reward.

The addition of a supplementary reward in the example of FIG. 12 is expressed as in expression (3).

$$\begin{matrix}[ Expression 3 ] & \\ {r}_{t , m}^{′} = \{ \begin{matrix}{r}_{t , m} & ( t IS FINAL TIME ) \\ {r}_{t , m} - \frac{1}{ε} max ( 0 , v + {\sum }_{i = 0}^{t} - {r}_{i , m} ) & ( t IS OTHER THAN FINAL TIME )\end{matrix} & ( 3 )\end{matrix}$$

When the condition relating to operation of the controlled object 300 is reflected in the reward as shown in FIG. 10 and expression (2), the term “−(1/ε)max(0, v+Σₜ₌₀^{t}−r_{t,m})” for reflecting the condition is added to the reward r_{t,m} of the final time step of the episode.

In the risk-sensitive history information shown in FIG. 11, the term “−(1/ε)max(0, v+Σₜ₌₀^{Tm}−r_{t,m})” for reflecting the condition is still added to the reward r_{t,m} of the final time step of the episode, and the value of the threshold v is changed from 1 to 0.5.

In contrast, in the addition of the supplementary reward shown in FIG. 12 and expression (3), the supplementary reward term “−(1/ε)max(0, v+Σₜ₌₀^{Tm}−r_{t,m})” is added to the reward r_{t,m} of a time step that is different from the final time step of the episode.

It can be said that, in the addition of the supplementary reward shown in FIG. 12 and expression (3), the same term as the term for reflecting the condition that is added to the reward of the final time step of the episode is added to the reward of a time step that is different from the final time step of the episode. In the example of the addition of the supplementary reward shown in FIG. 12 and expression (3), the supplementary reward is added with respect to a time step other than the final time step. However, the supplementary reward does not necessarily have to be added to all time steps. The supplementary reward may be added with respect to some of the time steps among the time steps other than the final time step.

In this way, by adding the supplementary reward term, it can be said that an alteration has been made that causes the difference in the evaluation function between time steps of evaluation relating to operation of the controlled object 300 to be reduced. As a result of a reduction in the difference in the evaluation function between time steps, the degree of change in the reward value decreases. In this respect, it is expected that the degree to which learning becomes difficult can be reduced.

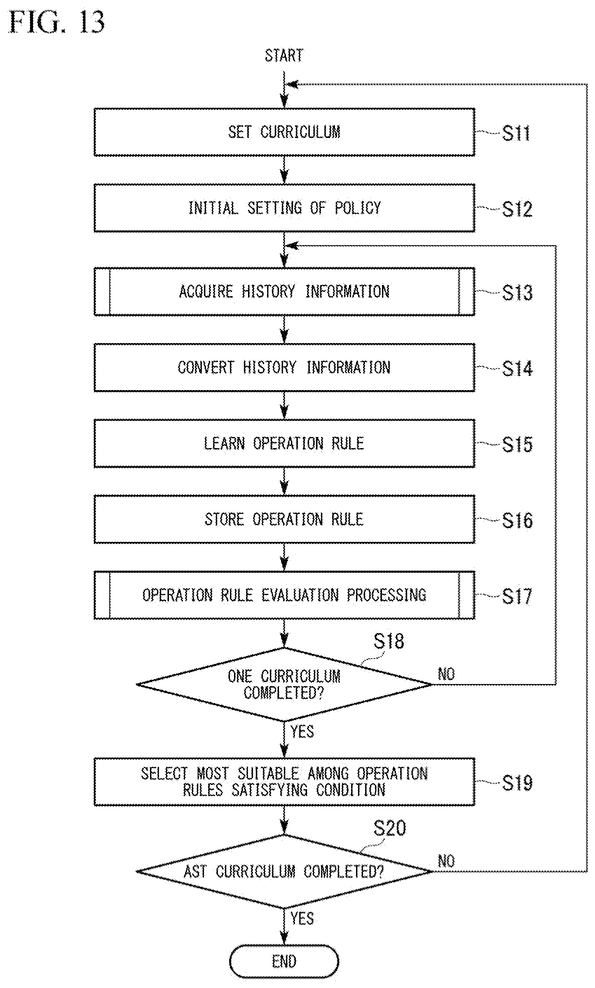

FIG. 13 is a diagram showing an example of a processing procedure by which the operation rule determination device 100 determines an operation rule of the controlled object 300 by learning.

In the processing of FIG. 13, the curriculum setting unit 191 sets a curriculum (step S11). For example, the curriculum setting unit 191 sets a three-stage curriculum in the order curriculum 0, 1, and 2.

For example, the curriculum setting unit 191 sets, as curriculum 0, the learning illustrated in FIG. 12 that uses a reward in which the threshold has been altered and to which a supplementary reward has been added. Furthermore, the curriculum setting unit 191 sets, as curriculum 1, the learning illustrated in FIG. 11 that uses a reward in which the threshold has been altered. Moreover, the curriculum setting unit 191 sets, as curriculum 2, the learning illustrated in FIG. 10 that uses a reward in which the condition relating to the controlled object 300 has been reflected.

The learning of curriculum 2 can be said to be learning under a condition to be satisfied by the operation rule of the controlled object 300. That is to say, the learning of curriculum 2 can be said to be learning for determining the operation rule that the learning unit 195 finally determines.

As a result of the curriculum setting unit 191 setting the curriculum in stages from relatively easy learning to relatively difficult learning, the learning unit 195 can use the learning result of the relatively easy learning in the relatively difficult learning, and it is expected that the learning can be efficiently performed. For example, the learning unit 195 can set the operation rule (policy) obtained in the relatively easy learning as the initial value of the learning rule in the relatively difficult learning.

When setting the curriculum in step S11, the evaluation function setting unit 192 sets the reward function corresponding to the curriculum.

Then, the learning unit 195 performs an initial setting of the operation rule in the curriculum (step S12). For example, in curriculum 0 (first curriculum), the learning unit 195 sets the operation rule to a predetermined operation rule. In curriculum 1 and 2, the learning unit 195 sets the operation rule to the operation rule obtained in the previous curriculum.

Next, the history information acquisition unit 193 acquires history information (step S13). The history information acquisition unit 193 may acquire the history information by performing a simulation of the operation of the controlled object 300. Alternatively, the history information acquisition unit 193 may acquire the history information that is obtained as a result of the control device 200 controlling the controlled object 300. The controlled object 300 causes the history information storage unit 183 to store the acquired history information.

Then, the history information conversion unit 194 converts the history information according to the curriculum set by the curriculum setting unit 191 (step S14). The history information conversion unit 194 causes the history information storage unit 183 to store the converted history information.

Next, the learning unit 195 learns the operation rule using the converted history information from the history information conversion unit 194 (step S15). For example, the learning unit 195 may update the values of the parameters of the operation rule by a policy gradient method using expression (4).

$$\begin{matrix}[ Expression 4 ] & \\ Δθ ← α \{ {\sum }_{m = 1}^{M} {\sum }_{t = 1}^{{T}_{m}} {r}_{t , m}^{′} {∇}_{θ} log π ( {a}_{t , m} \vert {s}_{t , m}^{′} , θ ) \} & ( 4 )\end{matrix}$$

Here, M represents the number of episodes. Tₘ represents the turn number in the mth episode. α is a coefficient for adjusting the magnitude by which a behavior rule parameter θ is updated.

π(a_{t,m}|s′_{t,m}, θ) represents the probability that the operation a_{t,m} is selected under state s′_{t,m} and the behavior rule parameter θ. ∇θ log π(a_{t,m}|s′_{t,m}, θ) represents differentiation of log π(a_{t,m}|s′_{t,m}, θ) with respect to θ. By changing the value of the behavior rule parameter θ in the direction of the slope indicated by ∇θ log π(a_{t,m}|s′_{t,m}, θ), the probability that the operation a_{t,m} is selected under the state s′_{t,m} and the behavior rule parameter θ increases.

If the value of the risk-sensitive reward r′ is positive, the learning unit 195 updates the value of the behavior rule parameter θ in the direction of the slope indicated by ∇θ log π(a_{t,m}|s′_{t,m}, θ). As a result, the probability that the operation a_{t,m} is selected under state s′_{t,m} and the behavior rule parameter θ increases.

On the other hand, if the value of the risk-sensitive reward r′ is negative, the learning unit 195 changes the value of the behavior rule parameter θ in the opposite direction to the direction of the slope indicated by ∇θ log π(a_{t,m}|s′_{t,m}, θ). As a result, the probability that the operation a_{t,m} is selected under state s′_{t,m} and the behavior rule parameter θ decreases.

The learning unit 195 uses expression (4) to update the value of the behavior rule parameter θ such that the cumulative value of the risk-sensitive reward r′ is maximized. As described above, the history information conversion unit 194 subtracts a penalty from the reward of an episode that includes a risk, which reduces the probability that operation of an episode including a risk will be selected.

However, the method by which the learning unit 195 learns the operation rule is not limited to a specific method. For example, as the method by which the learning unit 195 learns the operation rule, a known method that updates the operation rule based on a reward can be used.

The learning unit 195 stores the parameter values of the operation rule obtained in the learning in the policy parameter storage unit 182 (step S16).

Then, the learning unit 195 performs operation rule conversion processing (step S17).

In the operation rule conversion processing, the learning unit 195 calculates an evaluation value of the obtained operation rule, and compares the evaluation value with the evaluation value of the operation rule obtained in the previous execution of step S15. When the evaluation value of the operation rule obtained in the previous execution of step S15 is larger, the learning unit 195 treats the current execution of step S15 as if it had not occurred. In this case, the learning unit 195 deletes the parameter values of the operation rule obtained in the current execution of step S15 from the policy parameter storage unit 182, and once again sets the parameter values of the operation rule obtained in the previous execution of step S15 as temporarily adopted parameter values.

However, the operation rule conversion processing is not essential. Therefore, the operation rule determination device 100 may execute step S18 after step S16 without performing the processing of step S17.

Then, the curriculum setting unit 191 determines whether or not the processing for one curriculum has been completed (step S18).

For example, when “average return >1.0” and a constraint satisfaction rate of 90% is met, the curriculum setting unit 191 may determine that the processing for one curriculum has been completed.

Alternatively, the curriculum setting unit 191 may set a different completion condition for each curriculum.

If the curriculum setting unit 191 determines that the processing for one curriculum has not been completed (step S18: NO), the processing returns to step S13.

On the other hand, if the curriculum setting unit 191 determines that the processing for one curriculum has been completed (step S18: YES), the learning unit 195 selects, as the learning result, the operation rule with the largest expected value of the return from among the operation rules that satisfy the condition obtained in the curriculum (step S19).

Then, the curriculum setting unit 191 determines whether or not the final curriculum has been completed (step S20).

If the curriculum setting unit 191 determines that the final curriculum has not been completed (step S20: NO), the processing returns to step S11.

On the other hand, if the curriculum setting unit 191 determines that the final curriculum has been completed (step S20: YES), the operation rule determination device 100 completes the processing of FIG. 13.

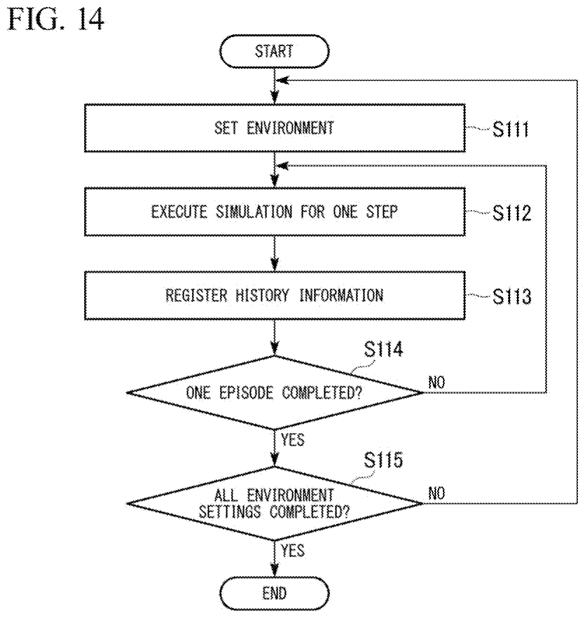

FIG. 14 is a diagram showing an example of a processing procedure performed in a case where the history information acquisition unit 193 acquires history information by simulation. The history information acquisition unit 193 performs the processing of FIG. 14 in step S13 of FIG. 13.

In the processing of FIG. 14, the history information acquisition unit 193 sets the environment (step S111). Specifically, the history information acquisition unit 193 includes a simulation model including environmental parameters, and sets the environment by setting the values of the environmental parameters.

In the example from FIG. 3 to FIG. 7, examples of the environmental parameters include the slipperiness of the floor, such as the frictional resistance value of the floor. However, the environmental parameters in the simulation model included in the history information acquisition unit 193 are not limited to specific parameters.

Then, the history information acquisition unit 193 executes one step of the simulation (step S112). Here, one step of the simulation represents processing that performs one cycle consisting of a calculation of the operation of the controlled object 300, and calculation of the state after the operation of the controlled object 300.

One step of the simulation corresponds to one time step and one turn of an episode.

Next, the history information acquisition unit 193 stores, as the history information for one step, the operation of the controlled object 300 in step S112 and information representing the calculated state, in the history information storage unit 183 (step S13). When the history information storage unit 183 stores history information, the history information acquisition unit 193 adds the history information for one step to the history information that is stored by the history information storage unit 183.

The history information acquisition unit 193 may calculate a reward value and include the reward value in the history information. Alternatively, the history information acquisition unit 193 or the learning unit 195 may calculate the reward value after the fact, based on the operation of the controlled object 300 and the state.

Then, the history information acquisition unit 193 determines whether or not the simulation for one episode has been completed (step S114). Specifically, the history information acquisition unit 193 determines whether or not a completion condition of the episode is satisfied.

In the example from FIG. 3 to FIG. 7, examples of the completion condition of the episode include a condition in which a predetermined number of turns in the episode have proceeded, or the hopper 801 has fallen over. However, the completion condition of the episode is not limited to a specific condition.

If the history information acquisition unit 193 determines that the simulation for one episode has not been completed (step S114: NO), the processing returns to step S112.

On the other hand, if it is determined that the simulation for one episode has been completed (step S114: YES), the history information acquisition unit 193 determines whether or not the environmental settings to be simulated have all been executed (step S115). For example, the history information acquisition unit 193 determines whether or not the settings of the environmental parameters, for which a plurality of combinations have been set, have all been executed.

If the history information acquisition unit 193 determines that there is an environmental setting that has not been executed (step S115: NO), the processing returns to step S111.

On the other hand, if it is determined that the environmental settings to be simulated have all been executed (step S115: YES), the history information acquisition unit 193 completes the processing of FIG. 14.

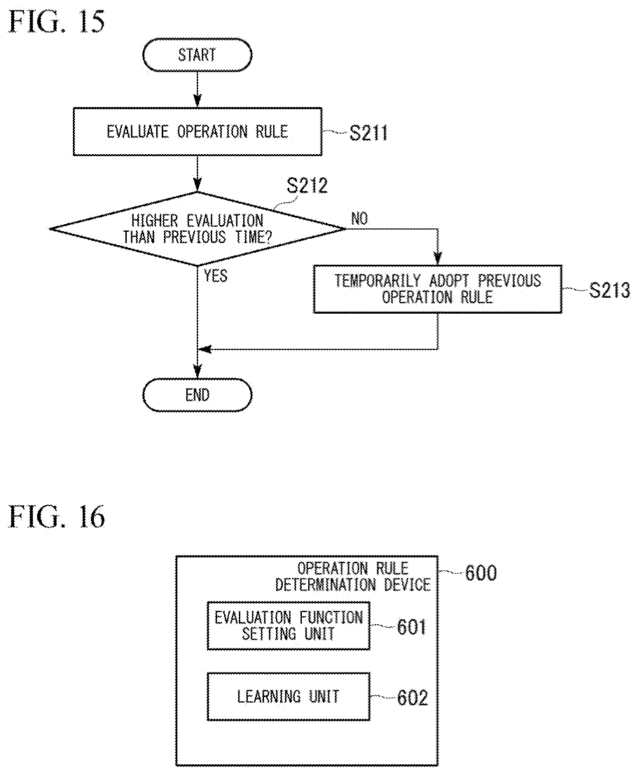

FIG. 15 is a diagram showing an example of a procedure by which the learning unit 195 performs operation rule evaluation processing. The learning unit 195 performs the processing of FIG. 15 in step S17 of FIG. 13.

In the processing of FIG. 15, the learning unit 195 evaluates the operation rule obtained in the current execution of step S15 in FIG. 13 (step S211).

The method by which the learning unit 195 evaluates the operation rule in step S211 is not limited to a specific method. For example, step S211 may output the operation rule to the history information acquisition unit 193 and cause execution of a simulation of the operation of the controlled object 300, and an evaluation index value may be calculated with respect to the state information obtained as a result of the operation of the controlled object 300.

Then, the learning unit 195 determines whether or not the operation rule obtained in the current execution of step S15 is a high evaluation that is greater than or equal to the operation rule obtained in the previous execution of step S15 (step S212). For example, the learning unit 195 may compare the evaluation index values calculated in step S211 for the operation rule obtained in the current execution of step S15 and the operation rule obtained in the previous execution of step S15.

If it is determined that the operation rule obtained in the current execution of step S15 has a high evaluation that is greater than or equal to the operation rule obtained in the previous execution of step S15 (step S212: YES), the learning unit 195 completes the processing of FIG. 15.

On the other hand, if it is determined that the operation rule obtained in the previous execution of step S15 has a higher evaluation (step S212: NO), the learning unit 195 treats the current execution of step S15 as if it had not occurred. In this case, the learning unit 195 deletes the parameter values of the operation rule obtained in the current execution of step S15 from the policy parameter storage unit 182, and once again sets the parameter values of the operation rule obtained in the previous execution of step S15 as temporarily adopted parameter values.

After step S213, the learning unit 195 completes the processing of FIG. 15.

As described above, the evaluation function setting unit 192 sets a second evaluation function that has been altered from a first evaluation function in which a condition relating to operation of the controlled object 300 is reflected, such that a difference in an evaluation function between time steps of evaluation relating to operation of the controlled object 300 is reduced. The learning unit 195 uses the second evaluation function to learn the operation rule of the controlled object 300. Further, the learning unit 195 uses the learning result of the learning using the second evaluation function, and the first evaluation function to learn the operation rule of the controlled object 300.

The learning using the second evaluation function is expected to be easier than the learning using the first evaluation function because the difference in the evaluation function between time steps is small, which results in a small amount of change in the evaluation value. As a result of the learning unit 195 using the learning result of the learning using the second evaluation function, it is expected that the learning using the first evaluation function can be performed relatively easily. As described above, according to the operation rule determination device 100, when learning the operation rule of the controlled object 300, and setting the conditions relating to operation causes the learning to become relatively difficult, it is possible to take measures to reduce the degree to which the learning becomes difficult.

Furthermore, the first evaluation function is set such that the condition relating to operation of the controlled object 300 is reflected in the final time step among the time steps of the series of operations of the controlled object. The evaluation function setting unit 192 generates the second evaluation function from the first evaluation function, such that alternation is performed in which a condition based on a condition relating to operation of the controlled object 300 in the final time step is reflected, among the time steps of the series of operations of the controlled object 300, in a time step that is different from the final time step.

As a result, in the learning using the second evaluation function, the difference in the evaluation function between time steps of evaluation relating to operation of the controlled object 300 is reduced. According to the operation rule determination device 100, as a result of a reduction in the difference in the evaluation function between time steps, the degree of change in the reward value decreases. In this respect, it is expected that the degree to which the learning becomes difficult can be reduced.

Furthermore, the first evaluation function is set such that the evaluation relating to operation of the controlled object 300 is decreased when the evaluation relating to operation of the controlled object 300 is a lower evaluation than a threshold. The evaluation function setting unit 192 generates the second evaluation function from the first evaluation function, such that the threshold is altered so that the evaluation relating to operation of the controlled object 300 more likely becomes a high evaluation that is greater than or equal to the threshold.

In the learning using the second evaluation function, the frequency in which the evaluation decreases becomes lower than the case of the learning using the first evaluation function. In this respect, due to the evaluation function setting unit 192, it can be said that an alteration has been made that causes the difference in the evaluation function between time steps of evaluation relating to operation of the controlled object 300 to be reduced. According to the operation rule determination device 100, the frequency in which the evaluation decreases and the evaluation value suddenly changes between time steps becomes lower. In this respect, it is expected that the degree to which learning becomes difficult can be reduced.

Furthermore, the learning unit 195 once again sets an operation rule that has been previously set when the evaluation of an operation rule that has been set during learning of the operation rule is lower than a predetermined condition.

According to the operation rule determination device 100, when the learning fails, it is possible to return the learning result to a state before the learning failed. As a result, it is expected that the learning can be efficiently performed.

FIG. 16 is a diagram showing an example of a configuration of an operation rule determination device according to an example embodiment. In the configuration shown in FIG. 16, the operation rule determination device 600 includes an evaluation function setting unit 601 and a learning unit 602.

In this configuration, the evaluation function setting unit 601 sets a second evaluation function that has been altered from a first evaluation function in which a condition relating to operation of the controlled object is reflected, such that a difference in an evaluation function between time steps of evaluation relating to operation of the controlled object is reduced. The learning unit 602 learns the operation rule of the controlled object using the second evaluation function, and learns the operation rule of the controlled object using the learning result and the first evaluation function.

The learning using the second evaluation function is expected to be easier than the learning using the first evaluation function because the difference in the evaluation function between time steps is small, which results in a small amount of change in the evaluation value. As a result of the learning unit 602 using the learning result of the learning using the second evaluation function, it is expected that the learning using the first evaluation function can be performed relatively easily. As described above, according to the operation rule determination device 600, when learning the operation rule of the controlled object, and setting the conditions relating to operation causes the learning to become relatively difficult, it is possible to take measures to reduce the degree to which the learning becomes difficult.

The evaluation function setting unit 601 can be implemented using, for example, the functions of the evaluation function setting unit 192 shown in FIG. 2 and the like. The learning unit 602 can be implemented using, for example, the functions of the learning unit 195 shown in FIG. 2 and the like.

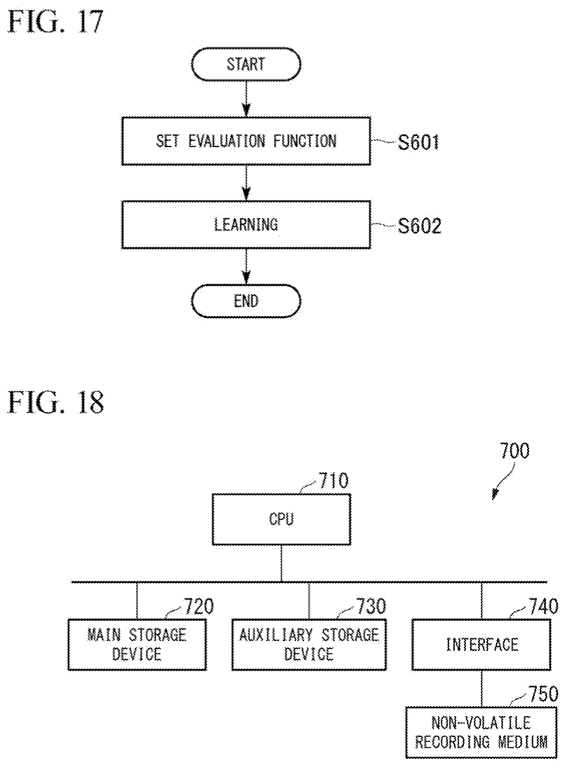

FIG. 17 is a diagram showing an example of the processing procedure of an operation rule determination method according to an example embodiment. The processing shown in FIG. 17 includes setting an evaluation function (step S601) and performing learning (step S602).

In the step of setting an evaluation function (step S601), a computer sets a second evaluation function that has been altered from a first evaluation function in which a condition relating to operation of the controlled object is reflected, such that a difference in an evaluation function between time steps of evaluation relating to operation of the controlled object is reduced.

In the step of performing learning (step S602), a computer learns the operation rule of the controlled object using the second evaluation function, and learns the operation rule of the controlled object using the learning result and the first evaluation function.

The learning using the second evaluation function is expected to be easier than the learning using the first evaluation function because the difference in the evaluation function between time steps is small, which results in a small amount of change in the evaluation value. In the processing of step S602, by using the learning result of the learning using the second evaluation function, it is expected that the learning using the first evaluation function can be performed relatively easily. As described above, according to the processing shown in FIG. 17, when learning an operation rule of the controlled object, and setting the conditions relating to operation causes the learning to become relatively difficult, it is possible to take measures to reduce the degree to which the learning becomes difficult.

FIG. 18 is a schematic block diagram showing a configuration of a computer according to at least one example embodiment.

In the configuration shown in FIG. 18, a computer 700 includes a CPU 710, a main storage device 720, an auxiliary storage device 730, an interface 740, and a non-volatile recording medium 750.

Any one or more of the operation rule determination device 100, the control device 200, and the operation rule determination device 600, or portions thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Furthermore, the CPU 710 reserves a storage area corresponding to each of the storage units mentioned above in the main storage device 720 according to the program. The communication of each device with other devices is executed as a result of the interface 740 having a communication function and performing communication according to the control of the CPU 710. Moreover, the interface 740 includes a port for the non-volatile recording medium 750, and reads information from the non-volatile recording medium 750 and writes information to the non-volatile recording medium 750.

When the operation rule determination device 100 is implemented by the computer 700, the operation of the control unit 190 and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area corresponding to the storage unit 180 and each unit thereof in the main storage device 720 according to the program. The communication performed by the communication unit 110 is executed as a result of the interface 740 having a communication function and performing communication according to the control of the CPU 710.

The interactions between the operation rule determination device 100 and the user is executed as a result of the interface 740 having an input device and an output device, presenting information to the user through the output device under the control of the CPU 710, and receiving user operations through the input device.

When the control device 200 is implemented by the computer 700, the operation thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area in the main storage device 720 for the control device 200 to perform processing according to the program. The communication between the control device 200 and other devices is executed as a result of the interface 740 including a communication function and operating under the control of the CPU 710.

The interactions between the control device 200 and the user is executed as a result of the interface 740 having an input device and an output device, presenting information to the user through the output device under the control of the CPU 710, and receiving user operations through the input device.

When the operation rule determination device 600 is implemented by the computer 700, the operation of the evaluation function setting unit 601 and the learning unit 602 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area in the main storage device 720 for the operation rule determination device 600 to perform processing according to the program. The communication between the operation rule determination device 600 and other devices is executed as a result of the interface 740 including a communication function and operating under the control of the CPU 710.

The interactions between the operation rule determination device 600 and the user is executed as a result of the interface 740 having an input device and an output device, presenting information to the user through the output device under the control of the CPU 710, and receiving user operations through the input device.

One or more of the programs described above may be recorded in the non-volatile recording medium 750. In this case, the interface 740 may read out the program from the non-volatile recording medium 750. Then, the CPU 710 directly executes the program that has been read out by the interface 740, or executes the program after temporarily saving the program in the main storage device 720 or the auxiliary storage device 730.

Furthermore, a program for executing some or all of the processing performed by the operation rule determination device 100, the control device 200, and the operation rule determination device 600 may be recorded in a computer-readable recording medium, and the processing of each unit may be performed by a computer system reading and executing the program recorded on the recording medium. The “computer system” referred to here is assumed to include an OS and hardware such as a peripheral device.

Furthermore, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into a computer system. Moreover, the program may be one capable of realizing some of the functions described above. Further, the functions described above may be realized in combination with a program already recorded in the computer system.

An example embodiment of the present invention has been described in detail above with reference to the drawings. However, specific configurations are in no way limited to the example embodiment, and include designs and the like within a scope not departing from the spirit of the present invention.

### INDUSTRIAL APPLICABILITY

The present invention may be applied to an operation rule determination device, an operation rule determination method, and a recording medium.

### DESCRIPTION OF REFERENCE SYMBOLS

1 Control system
100, 600 Operation rule determination device
110 Communication unit
180 Storage unit
181 Curriculum storage unit
182 Policy parameter storage unit
183 History information storage unit
190 Control unit
191 Curriculum setting unit
192, 601 Evaluation function setting unit
193 History information acquisition unit
194 History information conversion unit
195, 602 Learning unit
200 Control device
300 Controlled object

What is claimed is:

1. An operation rule determination device comprising:
a memory configured to store instructions; and
a processor configured to execute the instructions to:
set a second evaluation function that has been altered from a first evaluation function in which a condition relating to operation of a controlled object is reflected, such that a difference in an evaluation function between time steps of evaluation relating to the operation of the controlled object is reduced; and
perform learning on an operation rule of the controlled object using the second evaluation function, and perform learning on the operation rule of the controlled object using a learning result and the first evaluation function.

2. The operation rule determination device according to claim 1,
wherein the first evaluation function is set such that the condition is reflected in a final time step among time steps of a series of operations of the controlled object, and
the processor is configured to execute the instructions to generate the second evaluation function from the first evaluation function, such that alternation is performed in which a condition based on the condition of the final time step is reflected in a time step that is different from a final time step among time steps of a series of operations of the controlled object.

3. The operation rule determination device according to claim 1,
wherein the first evaluation function is set such that an evaluation relating to the operation of the controlled object is decreased when an evaluation relating to the operation of the controlled object is a lower evaluation than a threshold, and
the processor is configured to execute the instructions to generate the second evaluation function from the first evaluation function, such that the threshold is altered so that the evaluation relating to the operation of the controlled object easily becomes a high evaluation that is greater than or equal to the threshold.

4. The operation rule determination device according to claim 1, wherein the processor is configured to execute the instructions to once again set an operation rule that has been previously set when an evaluation of an operation rule that has been set during learning of the operation rule is lower than a predetermined condition.

5. An operation rule determination method executed by a computer, comprising:
setting a second evaluation function that has been altered from a first evaluation function in which a condition relating to operation of a controlled object is reflected, such that a difference in an evaluation function between time steps of evaluation relating to the operation of the controlled object is reduced; and
performing learning on an operation rule of the controlled object using the second evaluation function, and performing learning on the operation rule of the controlled object using a learning result and the first evaluation function.

6. A non-transitory recording medium that stores a program that causes a computer to execute:
setting a second evaluation function that has been altered from a first evaluation function in which a condition relating to operation of a controlled object is reflected, such that a difference in an evaluation function between time steps of evaluation relating to the operation of the controlled object is reduced; and
performing learning on an operation rule of the controlled object using the second evaluation function, and performing learning on the operation rule of the controlled object using a learning result and the first evaluation function.
